(19) United States
(12) Patent Application Publication
(10) Pub. No.: US 2013/0073356 A1
(43) Pub. Date: Mar. 21, 2013

(54) METHOD AND SYSTEM OF SPONSORED PUBLISHING

(71) Applicants: Thomas E. Cooper, Indianapolis, IN (US); Pamela A. Cooper, Indianapolis, IN (US)

(72) Inventors: Thomas E. Cooper, Indianapolis, IN (US); Pamela A. Cooper, Indianapolis, IN (US)

(21) Appl. No.: 13/622,324

(22) Filed: Sep. 18, 2012

Related U.S. Application Data
(60) Provisional application No. 61/536,036, filed on Sep. 18, 2011.

(51) Int. Cl. G06Q 30/02

(52) U.S. Cl. 705/14.5; 705/14.1

(57) ABSTRACT

A method and system of sponsored publishing is described. Compensation is provided to participants based on recruitment of merchants and actions by subscribers provided by a publisher. A publisher may determine offers provided via a publication.

### BACKGROUND

1. Field of the Invention

The invention relates to publishing systems and in particular to a system for sponsored electronic publishing.

2. Description of the Related Art

Current systems of publication of newsletters, or other types of publications to groups require that the publishing organization underwrite the costs of publication and distribution. This may be expensive for the publishing organization, and may discourage adequate communication. Some publications, especially those of non-profit organizations, may seek to defray the cost by advertising. However, such advertisements may have uncertain effect, and may require a sales activity which is not within the ability of the organization.

Electronic publishing has many advantages, but does not solve the problems described. Electronic newsletters still must be distributed, and may have trouble to avoid spam filters, retain interest of the audience, and attract suitable advertisers while providing value to the advertisers. Distribution systems by companies such as ExacTarget, or Silverpop may overcome email filter blocking, but may be costly for small entities,

In light of these and other issues, what is needed is a method and system of electronic publishing and advertising of offers associated with the publishing organization.

### SUMMARY

The system includes a server receiving promotional materials, receiving publications, managing approval of publications and promotional materials, registering publishers, registering advertisers, distributing publications including the promotional materials, and tracking compensation to the publishers and payments due. The system includes at least one promoter system providing promotional offers to be published. A promoter may be a merchant, an agency operating on behalf of merchants, or any person or entity providing offers or advertisements. The system includes at least one publisher system providing content which may be of interest to an organization or affiliated group. A trigger event is received which initiates a publication. Content associated with the event is retrieved, and information of a subscriber is obtained. An advertisement or promotional offer is retrieved based on information of the subscriber and the publication is distributed to the subscriber. Compensation is provided to a publisher, and a promoter based on subscriber activities associated with the offer,

A publication may be published electronically. A publication is targeted to a subscriber. Information of a subscriber may be provided by a publisher. A publisher provides registration and contact information which may include demographic, geographic and other targeting information which may be used to promote the audience of the publisher to a provider of promotional materials. Information of a merchant or provider of goods and/or services may be received from a promoter or advertiser. A publisher may have final approval of any or all promotional offers or advertisements which may be distributed with a publication. A publisher may approve offers or advertisements

A provider of promotional materials may provide any type of promotional offers. A promotional offer may be a discount offer, may be an offer which includes compensation which is provided to an organization associated with the publisher. Usage of promotional offers may be tracked in various ways. For example, a recipient of the publication may activate a URL which causes a coupon to be printed, may be provided with a promotion code, may register with a provider of goods or services using a unique identifier such as email, phone number, a computer readable code such as a bar code or QR label, etc. which may be used to track a purchase associated with a promotional offer, and to identify a subscriber, a promoter, and/or a publisher.

A publisher may earn compensation based on purchases by members who have registered with a merchant as described previously. A publisher may earn compensation based on recruitment. If a publisher identifies a provider of promotional materials, and the provider of promotional materials registers with the system, a portion of revenue from purchases associated with the provider of promotional materials may be allocated to the publisher. For example, for a predetermined time period, a percentage of revenue originating from promotional offers associated with a recruited provider of goods and/or services distributed by any publisher may be allocated to the recruiting publisher and/or organization. A publisher may distribute various publications, and a subscriber may be associated with multiple publications, promoters, and/or publishers. Various embodiments of the invention are described herein for the purposes of explanation but not limitation of the inventive concept.

Additional aspects and/or advantages will be set forth, in part, in the description which follows and, in part, will be apparent from the description, or may be learned by practice of the invention.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of a system embodiment.

FIG. 2 is a flowchart of a process of registering a publisher.

FIG. 3 is a flowchart of a process of registering a promoter.

FIG. 4 is a flowchart of a process of registering a subscriber.

FIG. 5 is a flowchart of a process of confirming a subscriber.

FIG. 6 is a flowchart of a process of importing a subscriber by a publisher.

FIG. 7 is a flowchart of a process of creating content.

FIG. 8 is a flowchart of a process of creating an offer.

FIG. 9 is a flowchart of a process of approving an offer.

FIG. 10 is a flowchart of a process of publishing.

FIG. 11 is a flowchart of a process of purchasing an offer.

FIG. 12 is a flowchart of a process of distributing compensation to a publisher.

FIG. 13 is a flowchart of a process of distributing compensation to a promoter.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

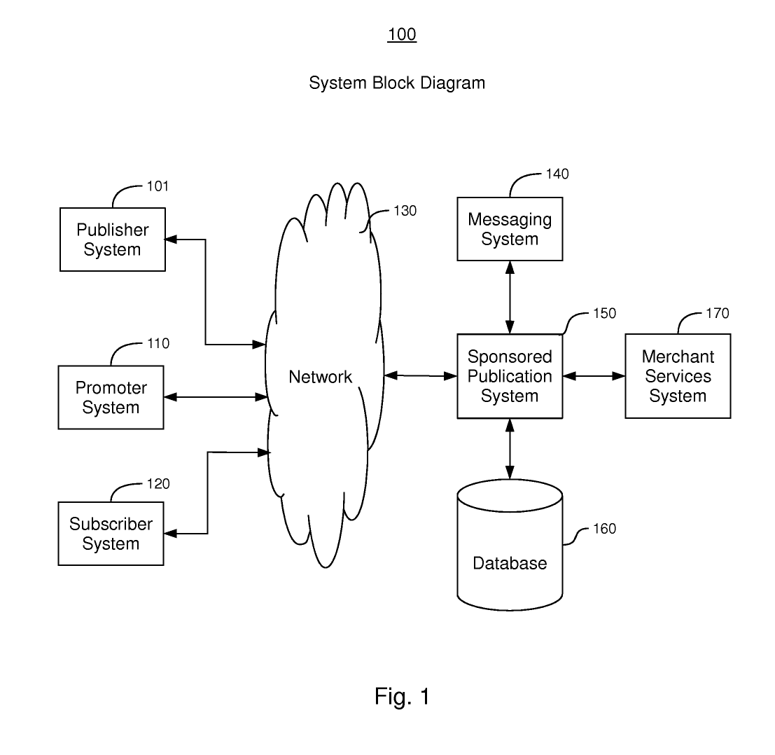

The system may be implemented using any suitable computer devices which are well known in the art. An exemplary system embodiment 100 is illustrated in FIG. 1. The system 100 may include a publisher system 101, a promoter system 110, a subscriber system 120, a network 130, a sponsored publication system 150, a database 160, a messaging system 140, and a merchant services system 170. While a single publisher system, promoter system, subscriber system, messaging system, and merchant service system are depicted in FIG. 1, it is envisioned that a plurality of publisher systems, promoter systems, subscriber systems, messaging systems and merchant service systems may be implemented.

The network 130 may consist of a public network of network (i.e., the internet) and/or may include any number of private networks. The network 130 may include various wireless communication services such as WiFi, GSM, LTE, WiFi and/or other wireless networks. The publisher system 101, the promoter system 110, the subscriber system 120, the sponsored publication system 150, the messaging system 140, and the merchant services system 170 may be implemented using any computing devices known in the art. For example, a PC, a Macintosh®, a mobile device such as wireless enabled laptop, tablet, or PDA, a specialized device, a smart phone, a server such as Dell™ PowerEdge™ blade servers may be used to implement any of the systems, which may run any suitable operating system such as Windows® 7, Linux, MacOS, etc. The database 160 may be implemented using hardware such as RAID, NAS, SAN, etc. using servers such as the IBM BladeCenter® HX5. The database 160 may be operated using software such as SQL, MySQL, Oracle® Database, etc.

The publisher system 101 may be used by a publisher to connect to the sponsored publication system 150 and provide registration information and/or content for publication and for other purposes. A publisher system may register with the sponsored publication system using a browser functionality associated with the publisher system 150. A publisher system may receive notifications when events occur which are relevant to the publisher. For example, an email, Short Messaging Service (SMS), Instant Messaging (IM), or other communication service registered by a publisher may be used to deliver a message to a publisher. The publisher system 101 may provide subscriber information.

The promoter system 110 may be used by a promoter to connect to the sponsored publication system 150. The promoter system 110 may provide registration information. The promoter system 110 may provide offer information and/or content. A promoter system may receive notifications when events occur which are relevant to the promoter. For example, an email, Short Messaging Service (SMS), Instant Messaging (IM), or other communication service registered by a promoter may be used to deliver a message to a promoter.

The subscriber system 120 may be used by a subscriber to connect to the sponsored publication system 150. The subscriber system 120 may provide registration information. The subscriber system 120 may provide subscription information. A subscriber system may receive notifications when events occur which are relevant to the subscriber. For example, an email, Short Messaging Service (SMS), Instant Messaging (IM), or other communication service registered by a subscriber may be used to deliver a message to a subscriber.

Registration information may be obtained using a browser functionality of a device or system. Registration information may be used to establish distribution of a sponsored publication to a subscriber. For example, email addresses may be provided by a subscriber and/or a publisher which may be used to distribute a sponsored publication using the messaging system 140.

The messaging system 140 may be a system associated with a messaging service such as email, IM, SMS, etc. The messaging system 140 may aggregate a subscriber list and distribute a sponsored publication according to a schedule.

The database 160 may store records of information associated with publishers, promoters, subscribers, merchants, publications, compensation, etc. which are processed during the operation of the embodiments. The sponsored publication system 150 allows communication to occur between publishers, subscribers, promoters, and merchants. The sponsored publication system may track compensation associated with participants in the publication system. The merchant services system 170 processes transactions with merchants. A merchant is a provider of a product and/or service associated with an offer provided by a promoter. The merchant services system 170 may inform a merchant and/or a promoter of offers purchased and/or may receive information of offers redeemed from a merchant. The merchant services system 170 provides payment and transaction services. For example, if a subscriber elects to purchase an offer, the merchant services system 170 may obtain credit card information, etc. to complete the transaction. A service such as the PayPal® service may act as the merchant services system 170. In particular this service may be desirable if the sponsored publication does not desire to be PCI compliant.

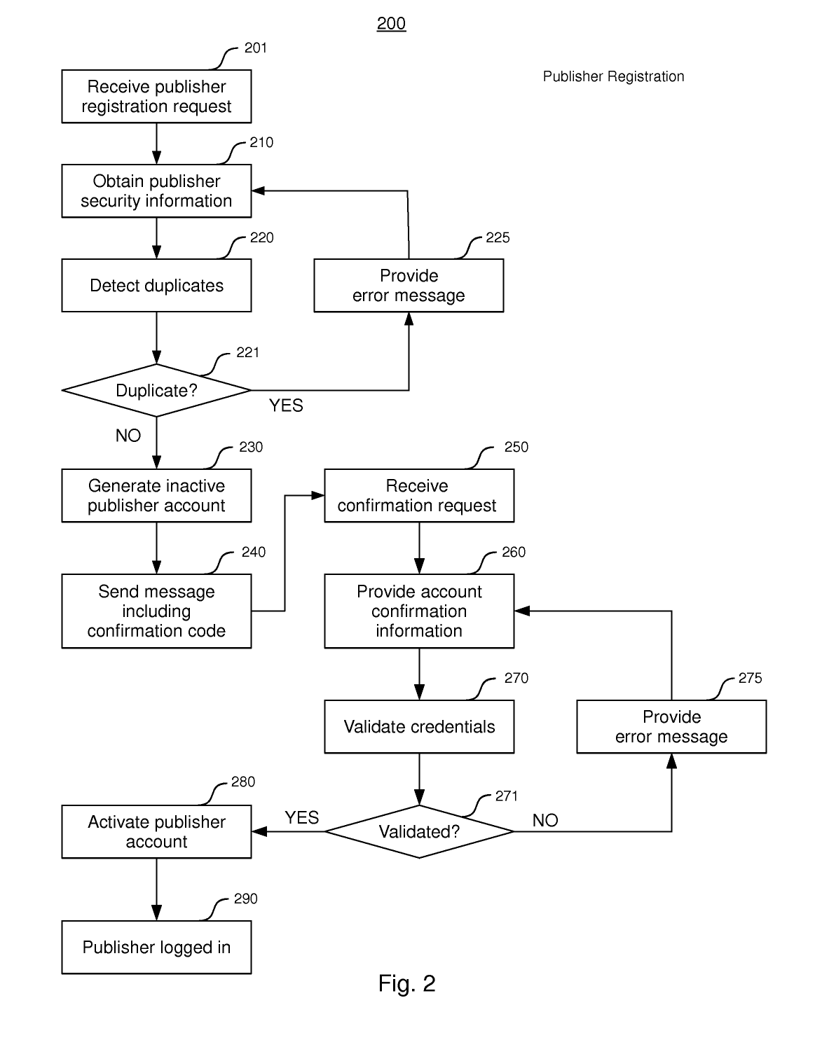

As illustrated in FIG. 2 a process 200 of registration of a publisher is provided. The process 200 may be used to obtain information of a publisher as required for registration. The process 200 may be operative on any suitable elements of the system 100 (FIG. 1). In at least one embodiment, the process 200 is operative on a server associated with the sponsored publication system 150.

In operation 201, a publisher registration request is received. For example, a browser may be pointed to a registration page. A registration page for a publisher may be provided in operation 201. Publisher registration may occur using credentials provided by a third party such as Facebook, or Twitter. Control is passed to operation 210 and process 200 continues. In operation 210 a publisher login identifier (ID) and security information is obtained. For example an email address, and user ID, a user generated password, etc. may be used as a password. Control is passed to operation 220 and process 200 continues. In operation 220 duplicate login ID's are detected. A requested login ID may be compared to a list of current login ID's, and/or user information such as email, phone number, etc. may be compared to that of an existing publisher. Control is passed to operation 221 and process 200 continues.

In operation 221 a determination is made as to whether a login ID is duplicated. If it is determined in operation 221 that a login ID is duplicated, control is passed to operation 225 and process 200 continues. If it is determined in operation 221 that a login ID is not duplicated, control is passed to operation 230 and process 200 continues. In operation 225 an error message is provided. Control is passed to operation 210 and process 200 continues.

In operation 230 an inactive publisher account is generated. Control is passed to operation 240 and process 200 continues. In operation 240 a message including a confirmation code is sent to a publisher. An email including a confirmation URL may be sent to an email address provided by a publisher. Control is passed to operation 250 and process 200 continues.

In operation 250 a determination is made as to whether a confirmation request is received. If in operation 250 it is determined that a confirmation URL is not activated, control remains at operation 250 and process 200 continues. If in operation 250 it is determined that a confirmation request is received, control is passed to operation 260 and process 200 continues.

In operation 260 an account confirmation is provided. For example, information of an inactive publisher account associated with a confirmation such as an email, user ID, password, etc., may be verified. Control is passed to operation 270 and process 200 continues. In operation 270 credential associated with an account are validated. Control is passed to operation 271 and process 200 continues. In operation 271 a determination is made as to whether a credential is valid. If in operation 271 it is determined that a credential is not valid, control is passed to operation 275 and process 200 continues. If in operation 271 it is determined that a credential is valid, control is passed to operation 280 and process 200 continues. In operation 275 and error message is provided. Control is passed to operation 260 and process 200 continues.

In operation 280 a publisher account is activated. Control is passed to operation 290 and process 200 terminates. In operation 290 a publisher is logged in.

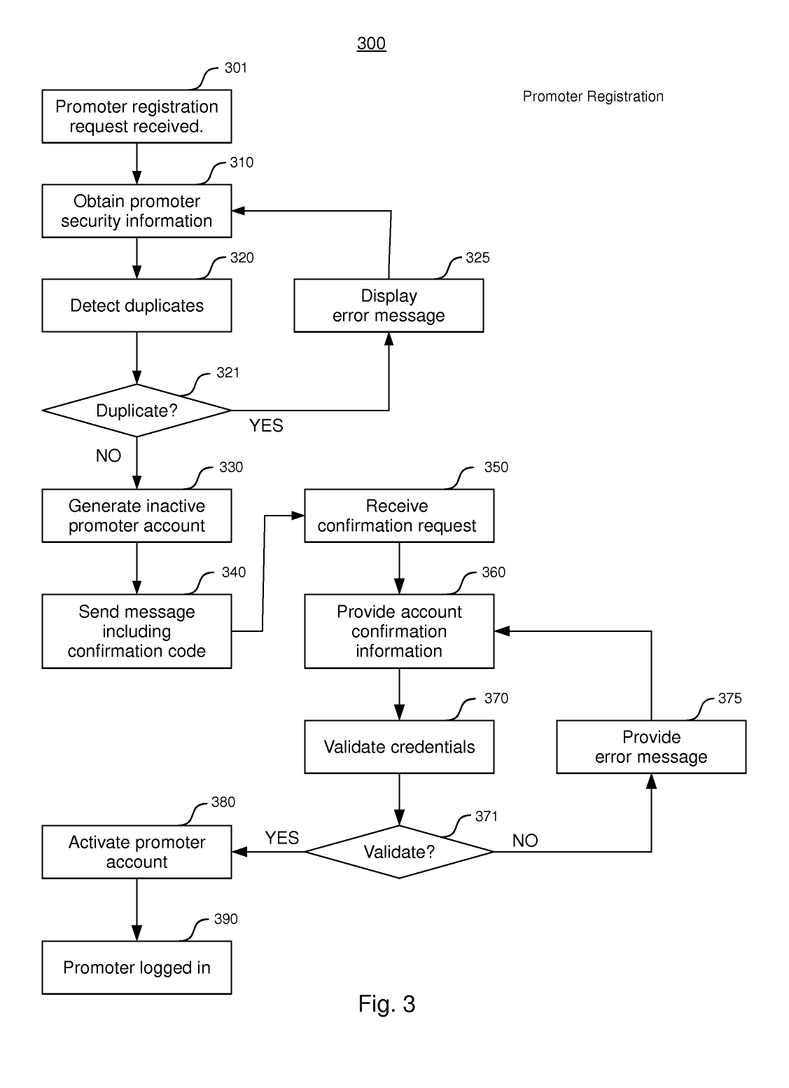

As illustrated in FIG. 3 a process 300 of registration of a promoter is provided. The process 300 may be used to obtain information of a promoter as required for registration. The process 300 may be operative on any suitable elements of the system 100 (FIG. 1). In at least one embodiment, the process 300 is operative on a server associated with the sponsored publication system 150.

In operation 301, a promoter registration request is received. For example, a browser is pointed to a registration page. A registration page for a promoter may be provided in operation 301. Promoter registration may occur using credentials provided by a third party such as Facebook, or Twitter. Control is passed to operation 310 and process 300 continues. In operation 310 promoter security information is obtained. For example an email address, and user ID, a user generated password, etc. may be used as a password. Control is passed to operation 320 and process 300 continues. In operation 320 duplicate login ID's are detected. A requested login ID may be compared to a list of current login ID's, and/or user information such as email, phone number, etc. may be compared to that of an existing promoter. Control is passed to operation 321 and process 300 continues.

In operation 321 a determination is made as to whether a login ID is duplicated. If it is determined in operation 321 that a login ID is duplicated, control is passed to operation 325 and process 300 continues. If it is determined in operation 321 that a login ID is not duplicated, control is passed to operation 330 and process 300 continues. In operation 325 an error message is provided. Control is passed to operation 310 and process 300 continues.

In operation 330 an inactive promoter account is generated. Control is passed to operation 340 and process 300 continues. In operation 340 a message including a confirmation code is sent to a promoter. An email including a confirmation URL may be sent to an email address provided by a publisher. Control is passed to operation 350 and process 300 continues.

In operation 350 a determination is made as to whether a confirmation request is received. If in operation 350 it is determined that a confirmation request is not received, control remains at operation 350 and process 300 continues. If in operation 350 it is determined that a confirmation request is received, control is passed to operation 360 and process 300 continues.

In operation 360 an account confirmation information is provided. For example, information of an inactive promoter account associated with a confirmation such as an email, user ID, password, etc., may be verified. Control is passed to operation 370 and process 300 continues. In operation 370 a credential associated with an account is validated. Control is passed to operation 371 and process 300 continues. In operation 371 a determination is made as to whether a credential is valid. If in operation 371 it is determined that a credential is not valid, control is passed to operation 375 and process 300 continues. If in operation 371 it is determined that a credential is valid, control is passed to operation 380 and process 300 continues. In operation 375 and error message is provided. Control is passed to operation 360 and process 300 continues.

In operation 380 a promoter account is activated. Control is passed to operation 390 and process 300 terminates. In operation 390 a promoter is logged in.

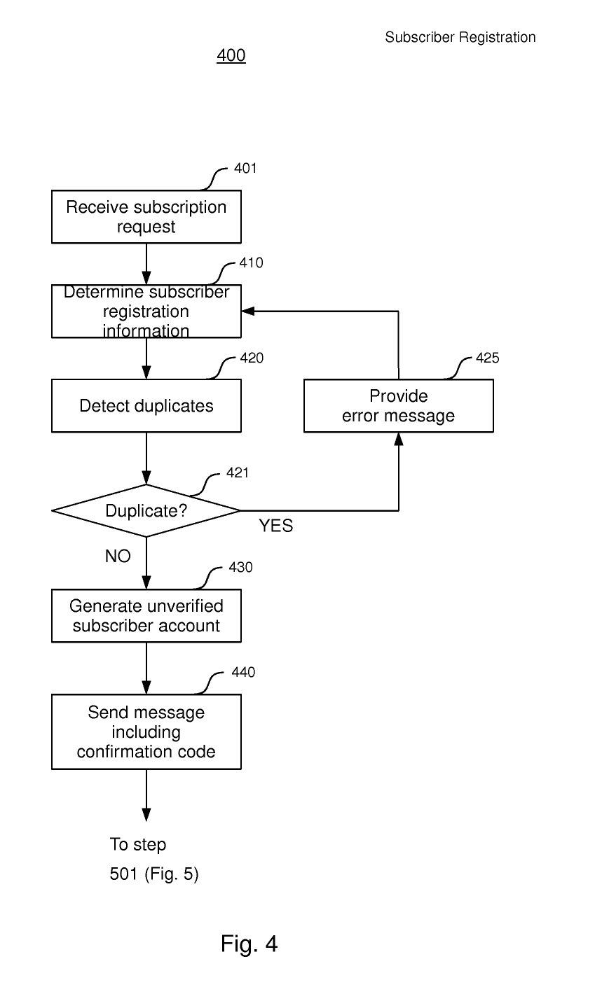

As illustrated in FIG. 4, a process 400 for registration of a subscriber is provided. The process 400 may be used by an individual subscriber to register with the publication system 150 (FIG. 1). For example, a web page provided by the publication system 150, or a publisher system might be used to register a subscriber. In at least one embodiment the process 400 may be operative on a server associated with the publication system 150.

In operation 401 a subscriber registration request is received. For example, a subscriber may navigate to a registration page of a publisher, or may send a message to a short code or Twitter® account associated with a publisher. Control is passed to operation 410 and process 400 continues. In operation 410 subscriber registration information is provided. For example, an email and password may be provided. Control is passed to operation 420 and process 400 continues. In operation 420 duplicate subscribers are detected. For example, unique data of a subscriber may be compared to unique data of other subscribers. Control is passed to operation 421 and process 400 continues. In operation 421 a determination is made as to whether a duplicate exists. If in operation 421 it is determined that a duplicate exists, control is passed to operation 425 and process 400 continues. If in operation 421 it is determined that a duplicate does not exist control is passed to operation 430 and process 400 continues. In operation 425 a subscriber registration error message is provided. Control is passed to operation 410 and process 400 continues.

In operation 430 an unverified subscriber account is generated. An unverified account may include registration information, but is pending confirmation by a user. A subscriber may receive publication information via a messaging identifier associated with the user even if a user account is not verified. Control is passed to operation 440 and process 400 continues. In operation 440 a confirmation message including a confirmation code is sent to an address associated with an unverified subscriber account. Control is passed to operation 501 and process 400 terminates.

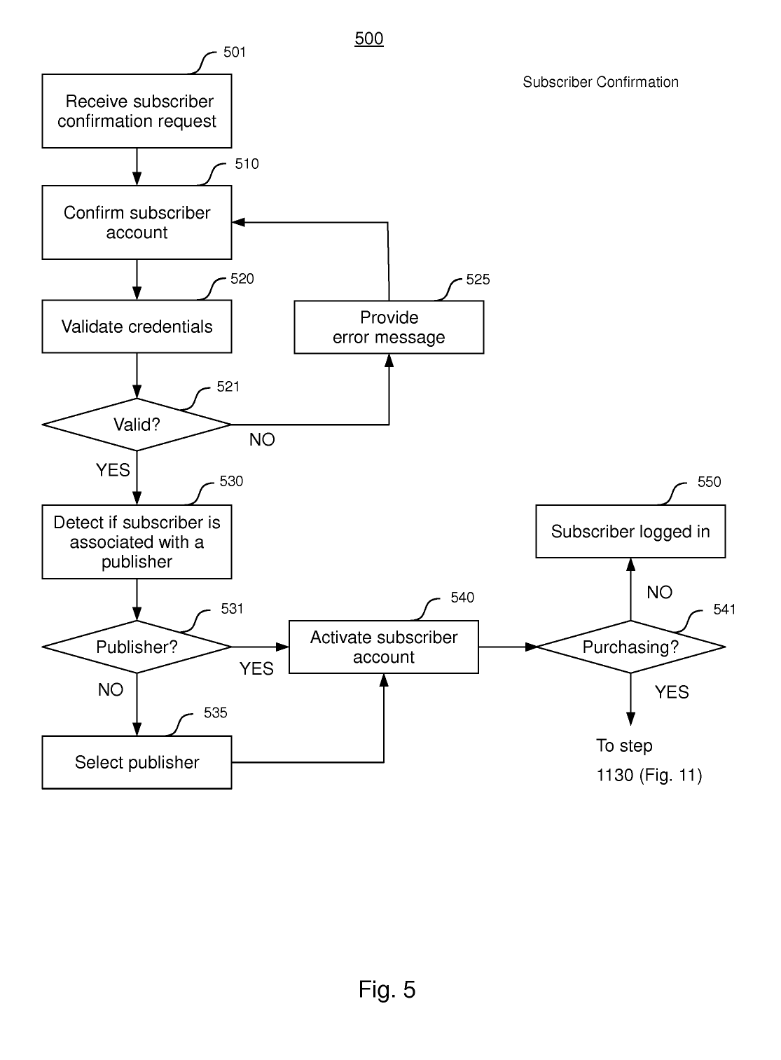

As illustrated in FIG. 5 a process 500 for confirmation of a subscriber is provided. The process 500 may be used to confirm a subscriber based on information provided by a subscriber and/or a publisher during a registration process. In at least one embodiment, the process 500 is operative on a server associated with the publication system 150 (FIG. 1).

In operation 501 a subscriber confirmation message is received. For example, a subscriber may activate a URL indicated in a confirmation email sent to an email address provided when the subscriber registers. A confirmation message may originate from various activities such as subscriber registration or importing of a subscriber list including the subscriber by a publisher. Control is passed to operation 510 and process 500 continues. In operation 510 a subscriber account is confirmed. For example, a subscriber may provide an email address and a password in a login web page provided to the subscriber system 120.

In operation 520 credentials are validated. A stored password and email and/or other information provided by a registration process may be compared to information provided by a subscriber. Control is passed to operation 521 and process 500 continues. In operation 521 a determination is made as to whether a credential is valid. If in operation 521 it is determined that a credential is valid, control is passed to operation 530 and process 500 continues. If in operation 521 it is determined that a credential is not valid control is passed to operation 525 and process 500 continues. In operation 525 a validation error message is provided. Control is passed to operation 510 and process 500 continues.

In operation 530 a publisher associated with subscriber is detected. For example, a database of publishers associated with email addresses and/or user ID's may be referenced. A check may be performed to determine whether a subscriber is associated with more than one publisher. A subscriber may elect to be associated with multiple publishers. In such an instance, advertisements may be selected for a subscriber based on multiple publishers. Compensation for a publisher may be based on a publication which has provided an offer or advertisement to the subscriber. Control is passed to operation 531 and process 500 continues. In operation 531 a determination is made as to whether a subscriber is associated with a publisher. If in operation 531 it is determined that a subscriber is not associated with a publisher control is passed to operation 535 and process 500 continues. If in operation 531 it is determined that a subscriber is associated with a publisher, control is passed to operation 540 and process 500 continues.

In operation 535 a publisher is selected. A publisher may be selected for example using a web page, or based on information provided by a publisher and/or a subscriber. For example, a URL which directs a subscriber to a server associated with the publisher may associate the subscriber with the publisher. Control is passed to operation 540 and process 500 continues. In operation 540 a subscriber account is activated. A subscriber may be able to access various features of the system once an account is activated. Control is passed to operation 541 and process 500 continues.

In operation 541 a determination is made as to whether a subscriber is purchasing. If in operation 541 it is determined that a subscriber is purchasing, control is passed to operation 1130 and process 500 terminates. If in operation 541 it is determined that a subscriber is not purchasing, control is passed to operation 550 and process 500 continues. In operation 550 a subscriber is logged in, and process 500 terminates.

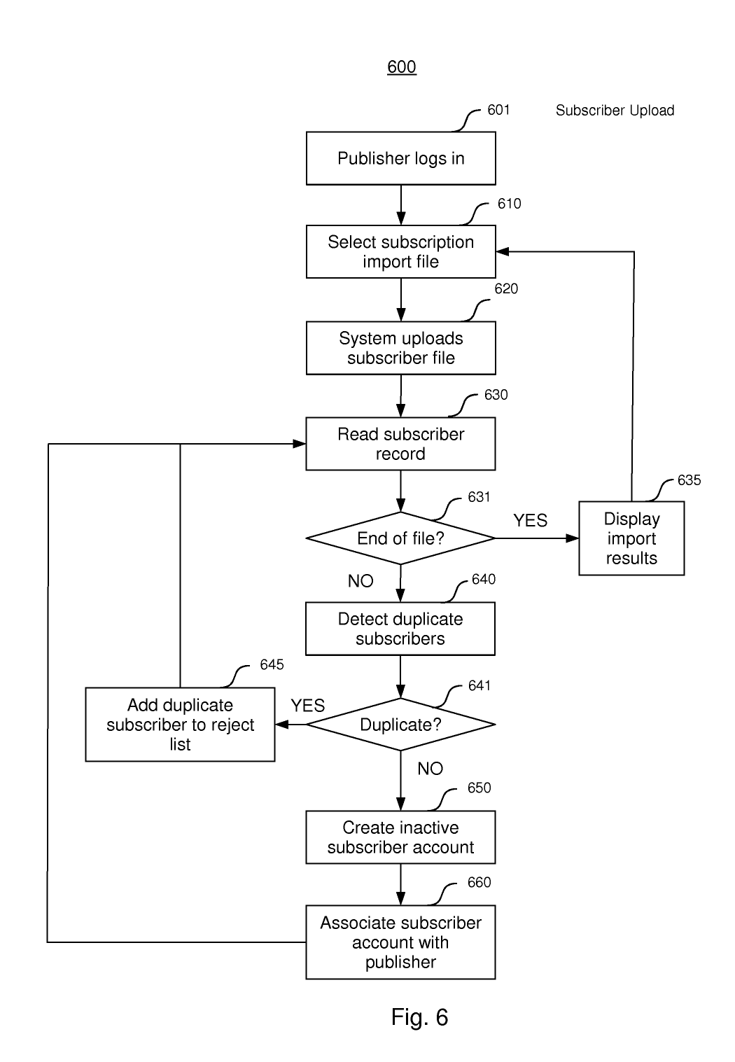

As illustrated in FIG. 6, a process 600 for importing subscribers by a publisher is provided. The process 600 may be used by a publisher with an active account. For example, the publisher system 101 may login to the publication system 150 using a browser functionality of the publisher system 101 to import a list of subscribers to a publication of a publisher. In at least one embodiment, the process 600 is operative on a server associated with the publication system 150.

In operation 601 a publisher logs in. Control is passed to operation 610 and process 600 continues. In operation 610 a subscription import file is selected. For example, a publisher may designate a location of a file on a local storage which describes a subscriber. A publisher may designate a publication which is to be associated with a subscriber. Control is passed to operation 620 and process 600 continues. In operation 620 a subscriber file is uploaded by the system. A publisher may be associated with any number of publications. A publisher may select an origination address for a publication. Content may be published to different lists of subscribers using a different publication and/or a different distribution list. A publication may be distributed to different subscribers using media and distribution channels associated with subscribers and the publication. For example, a publication may be sent to a distribution list of subscribers as a preview, and subsequently published to a different group or list of subscribers. Control is passed to operation 630 and process 600 continues.

In operation 630 a subscriber record is read. Information required to register a subscriber may be verified from the record. Control is passed to operation 631 and process 600 continues. In operation 631 a determination is made as to whether an end of file marker is detected. If in operation 631 it is determined that an end of file marker is detected control is passed to operation 635 and process 600 continues. If in operation 631 it is determined that an end of file marker is not detected, control is passed to operation 640 and process 600 continues. In operation 635 import results are provided. For example, a publisher may be provided with a display of information of imported subscribers, failed subscriber imports, duplications with existing subscribers, additional communication services and/or addresses associated with a subscriber, etc. Control is passed to operation 610 and process 600 continues.

In operation 640 a duplicate subscriber is detected. Control is passed to operation 641 and process 600 continues. In operation 641 a determination is made as to whether a subscriber record duplicates existing subscriber information. If in operation 641 it is determined that a subscriber is a duplicate control is passed to operation 645 and process 600 continues. If in operation 641 it is determined that a subscriber is not a duplicate control is passed to operation 650 and process 600 continues.

In operation 645 a duplicate subscriber record is added to a reject list. Information of rejected subscriber data may be provided to a publisher. Control is passed to operation 630 and process 600 continues. In operation 650 an initialized account associated with subscriber is created. In at least one embodiment, a confirmation email is sent to the subscriber. A message may be sent to a subscriber using a communication service associated with the subscriber, which may instruct the subscriber to verify the account. In at least one embodiment, a publication may be directed to a subscriber when the subscriber account is not verified. Control is passed to operation 660 and process 600 continues. In operation 660 a subscriber account is associated with a publisher. For example, a publisher performing the upload operation may be associated with the subscriber, or a publisher indicated in the uploaded file may be associated with a subscriber. At least one publisher is associated with a subscriber when a subscriber account is initialized. Control is passed to operation 630 and process 600 continues.

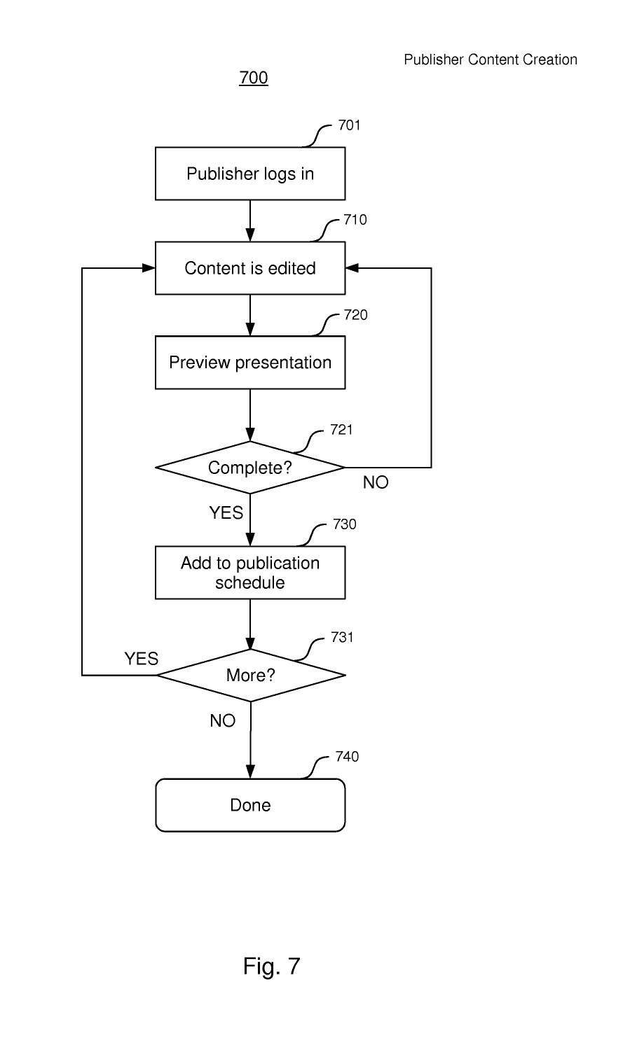

As illustrated in FIG. 7, a process 700 for creating content by a publisher is provided. The process 700 may be used by a publisher system to create and edit content which is scheduled for publication to a subscriber associated with the publisher. The process 700 may be operative on any suitable elements of the system 100 (FIG. 1). In at least one embodiment, the process 700 is operative on a server associated with the publication system 150 (FIG. 1).

In operation 701 a publisher logs in. For example, a publisher with an active account may connect to the publication system 150 (FIG. 1). A publisher may send a message such as a Tweet, an IM, an SMS, a voice call, etc. to an address associated with the publication system 150. Control is passed to operation 710 and process 700 continues. In operation 710 content is edited. For example, a publisher may edit and/or create content such as a news letter, bulletin, notice, etc. which may contain any media deliverable by the publisher system 150. A publisher may designate one or more publications associated with the publisher with the content. A publisher may create a collection of media such as photos, URL's, videos, etc. A publisher may designate locations for advertisements or offers, and may create URL's pointing to content which may be distributes as social media postings. Control is passed to operation 720 and process 700 continues. In operation 720 a presentation is previewed. For example, a newsletter or other media may be previewed according to a format determined by the publication system 150 and/or the publisher. Offers and/or advertisements may be provided as previews. Control is passed to operation 721 and process 700 continues.

In operation 721 a determination is made as to whether content editing is complete. If in operation 721 it is determined that content editing is not complete control is passed to operation 710 and process 700 continues. If in operation 721 it is determined that content editing is complete control is passed to operation 730 and process 700 continues. The determination in operation 721 may be based on various criteria. For example, activation of a control by a publisher, confirmation of acceptability of content provided, completion of a message, etc. may be used to determine whether content editing is complete.

In operation 730 content of a publisher is added to a publication schedule. A publication schedule or calendar may be defined according to various criteria. For example, periodic publication, publication triggered by an action of a publisher, etc. Information of a publication calendar may be provided to a promoter and/or a merchant. In at least one embodiment, a publication is published when editing is complete. Control is passed to operation 731 and process 700 continues. In operation 731 a determination is made as to whether more content is to be provided by the publisher. If in operation 731 it is determined that more content is to be provided by the publisher control is passed to operation 710 and process 700 continued. If in operation 731 it is determined that more content is not to be provided by the publisher control is passed to operation 740 and process 700 terminates.

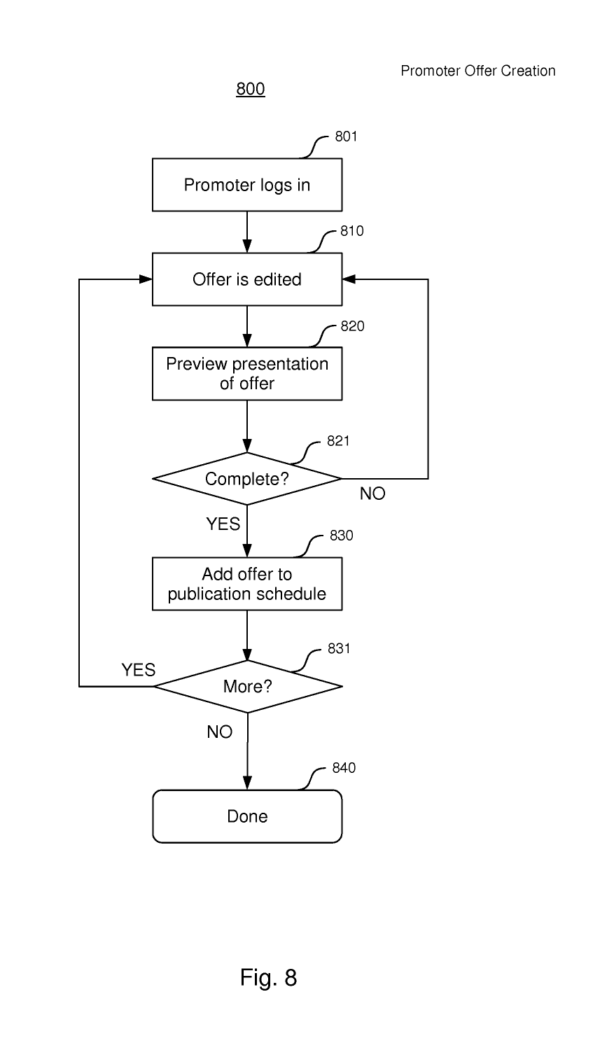

As illustrated in FIG. 8, a process 800 for creating an offer by a promoter is illustrated. The process 800 may be operative on any suitable element of the system 100 (FIG. 1). In at least one embodiment the process 800 is operative on a server associated with the publication system 150. The promoter system 110 may login to the publisher system 150 using a browser functionality of the promoter system 110. A promoter may be a merchant, may be an individual obtaining offers or recruiting merchants, may be an advertiser or advertising agency, and/or may be an entity representing one or more merchants. A promoter may have any number of active offers present in the database, which may be targeted in various ways. A promoter may be provided with information regarding publication, acceptance and performance of offers. An offer may be controlled based on time, location, affiliation, publication, and/or combinations of any information available in the database 160.

In operation 801 a promoter logs in. For example, a promoter with an active account may provide login credentials to a server. Control is passed to operation 810 and process 800 continues. In operation 810 an offer is edited. For example, a template and/or web form may be provided to a promoter to assist in creation of an offer. Control is passed to operation 820 and process 803 continues. In operation 820 an offer is previewed. For example, a promoter may be able to view an offer as it will appear in a publication provided by the publication system 150 (FIG. 1). Control is passed to operation 821 and process 800 continues.

In operation 821 a determination is made as to whether offer editing is complete. If in operation 821 it is determined that offer editing is not complete control is passed to operation 810 and process 800 continues. If in operation 821 it is determined that offer editing is complete control is passed to operation 830 and process 800 continues. The determination in operation 821 may be based on various criteria. For example, activation of a control by a promoter, confirmation of acceptability of offer provided, etc. may be used to determine whether offer editing is complete.

In operation 830 offer of a promoter is added to a publication schedule. A publication schedule may be defined according to various criteria. For example, periodic publication, publication triggered by an action of a publisher, publication based on a number of responses, publication based on a number of subscribers, etc. Information of a publication calendar may be provided to a promoter, a publisher, and/or a merchant. Control is passed to operation 831 and process 800 continues. In operation 831 a determination is made as to whether more offers are to be provided by the promoter. If in operation 831 it is determined that more offers are to be provided by the promoter control is passed to operation 810 and process 800 continued. If in operation 831 it is determined that more offers are not to be provided by the promoter control is passed to operation 840 and process 800 terminates.

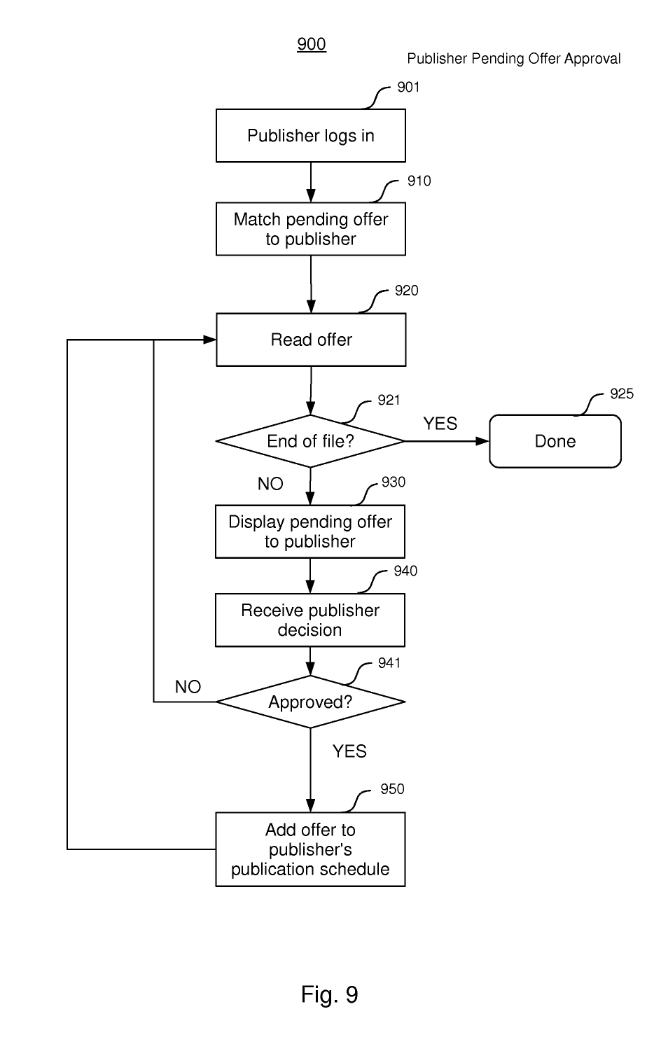

In at least one embodiment, a publisher may be able to approve offers published with content provided by the publisher and/or to subscribers associated with the publisher. A publisher may approve offers based on prior approval by an administrator. Offers may be associated with categories, which categories may be approved by a publisher for a publication. As illustrated in FIG. 9 a process 900 for approval of a pending offer by a publisher is provided. The process 900 may be operative on a server associated with the publisher system 150 (FIG. 1).

In operation 901 a publisher logs in. For example a publisher with an active account may provide login information. Control is passed to operation 910 and process 900 continues. In operation 910 a pending offer is matched to a publisher. For example, a profile of a publisher or publication or subscriber may be compared to targeting information associated with an offer to match an offer to a publisher. Control is passed to operation 920 and process 900 continues. In operation 920 an offer file is read. For example, content associated with an offer matching a criterion may be obtained. A publisher may select offers based on factors such as popularity, location, demographics, net return per delivery, etc. Control is passed to operation 921 and process 900 continues.

In operation 921 a determination is made as to whether a last matching offer is read. If in operation 921 it is determined that a last matching offer is read control is passed to operation 925 and process 900 terminates. If in operation 921 it is determined that a last matching offer is not read control is passed to operation 930 and process 900 continues. In operation 930 a pending offer is displayed. Content of an offer may be provided to a publisher. Control is passed to operation 940 can process 900 continues. In operation 940 a publisher decision is received. A publisher may indicate a judgment of an offer. If an offer is not approved within a time interval, it may be inferred that an offer is disapproved. Control is passed to operation 941 and process 900 continues.

In operation 941 a determination is made as to whether an offer is approved. If in operation 941 it is determined that an offer is not approved control is passed to operation 920 and process 900 continues. If in operation 941 it is determined that an offer is approved control is passed to operation 950 and process 900 continues. In operation 950 an offer is added to a publication schedule associated with the publisher. Control is passed to operation 920 and process 900 continues.

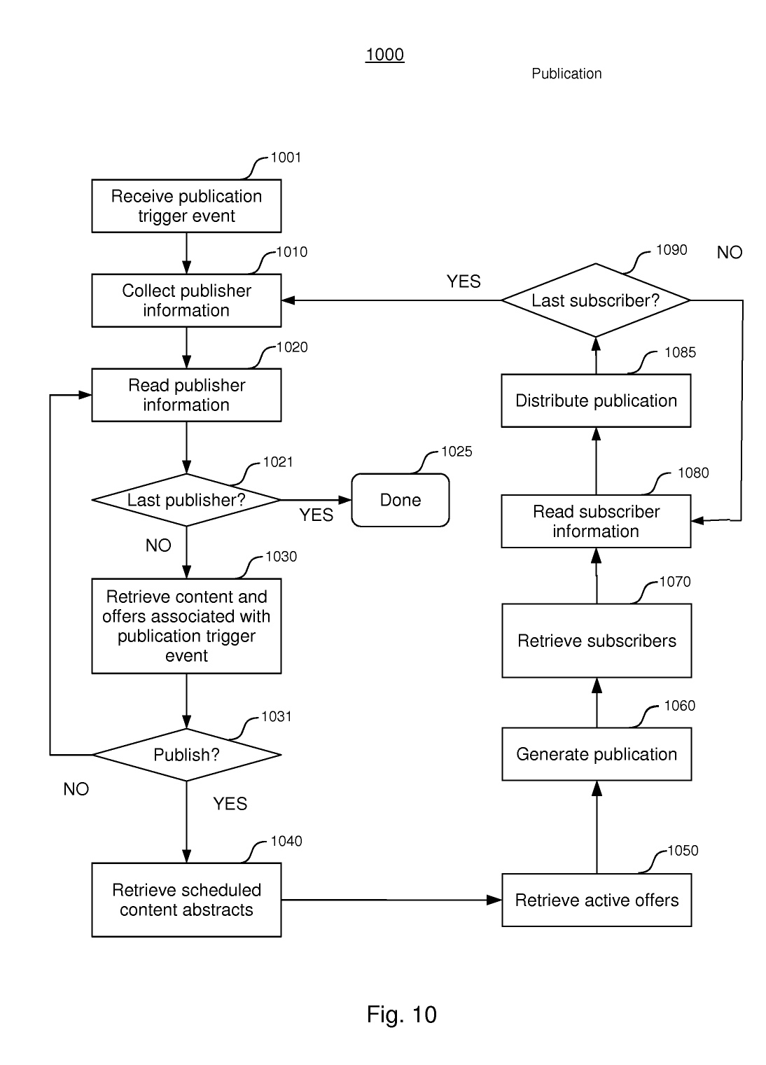

If a publication calendar or other event indicates that a publication is to be distributed, the publication system 150 may activate a distribution process. As illustrated in FIG. 10 a process 1000 of publication is provided. The process 1000 may be operative on any suitable elements of the system 100 (FIG. 1). The process 1000 may be operative on a server associated with the publisher system 150.

In operation 1001 an event triggering a publication is received. An event triggering a publication may be a recurring or periodic event such as a day of the week, month, etc., a spontaneous event such as an on-demand request of a publisher and/or promoter, etc. A trigger event may be provided by any element of the system 100. Control is passed to operation 1010 and process 1000 continues.

In operation 1010 publisher information is collected. For example publishers and/or publications associated with a trigger event may be determined. Any number of publishers may be collected. Control is passed to operation 1020 and process 1000 continues. In operation 1020 publisher information is read. For example, a record of a publisher associated with a trigger event may be read from the database 160. Control is passed to operation 1021 and process 1000 continues. In operation 1021 a determination is made as to whether a last publisher record is read. If in operation 1021 it is determined that a last publisher record is read control is passed to operation 1025 and process 1000 continues. If in operation 1021 it is determined that a last publisher record is not read control is passed to operation 1030 and process 1000 continues. In operation 1025 process 1000 terminates.

In operation 1030 content and offers associated with a trigger event are retrieved. For example, approved offers and content provided by a publisher associated with a trigger event may be obtained from the database 160. Control is passed to operation 1031 and process 1000 continues.

In operation 1031 a determination is made as to whether a publication is to be published. If in operation 1031 it is determined that a publication is not to be published, control is passed to operation 1020 and process 1000 continues. If in operation 1031 it is determined that a publication is to be published, control is passed to operation 1040 and process 1000 continues. The determination in operation 1031 may be based on various criteria. A number of available offers, a priority associated with a publication, a number of approved offers, history of a publisher and/or a promoter, etc. may be used to determine whether a publication is to be published.

In operation 1040 scheduled content abstracts are retrieved. Content which has not been previously published may take precedence. Control is passed to operation 1050 and process 1000 continues. In operation 1050 active offers are retrieved. Active offers may be determined based on factors such as information provided by a promoter such as targeting, offer value, etc. A total number of offers per publication may be limited. Offers may be selected based on content of a subscriber list of the publication, a blocked list of a publisher, etc. Control is passed to operation 1060 and process 1000 continues. In operation 1060 a publication is generated. The publication may for example be an email including content and offers, a social media posting including content and offers, and/or any message including content of a publisher and an offer. A publication may be generated automatically, and/or may be reviewed by a publisher. Control is passed to operation 1070 and process 1000 continues.

In operation 1070 subscribers are retrieved. A list of subscribers associated with a publication associated with a trigger event may be obtained. Control is passed to operation 1080 and process 1000 continues. In operation 1080 information of a subscriber is read. Offers and/or advertisements may be targeted to a subscriber based on information of the subscriber such as location, other subscriptions, affiliations, location, demographics, etc. Control is passed to operation 1085 and process 1000 continues. In operation 1085 a publication is distributed. The messaging service 1040 (FIG. 1) may distribute a publication. For example, an email may be distributed to subscribers associated with a publication using an email address provided by a publisher. A Tweet might be delivered to a subscriber from a Twitter handle associated with a publisher. Any available messaging service may be used to distribute a publication. Control is passed to operation 1090 and process 1000 continues. In operation 1090 a determination is made as to whether a last subscriber record is read. If in operation 1090 it is determined that a last subscriber record is read control is passed to operation 1010 and process 1000 continues. If in operation 1090 it is determined that a last subscriber record is not found control is passed to operation 1080 and process 1000 continues.

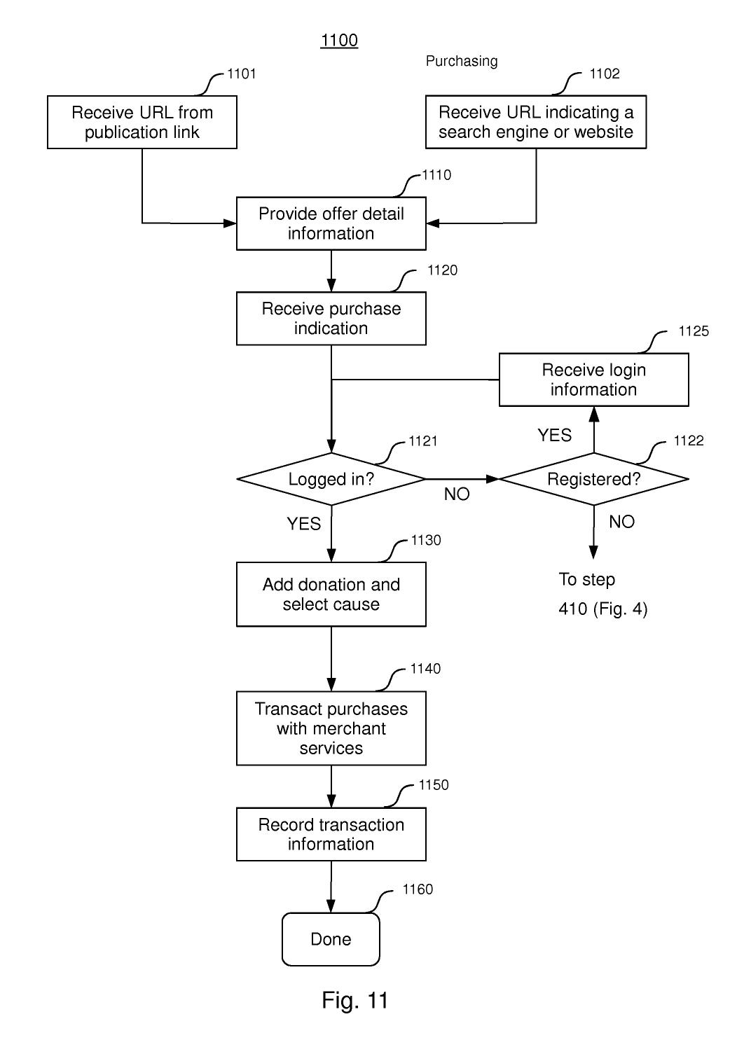

If an offer has been distributed, the system 100 creates compensation through the purchase of offers. As illustrated in FIG. 11 a process 1100 for purchasing is provided. The process 1100 may be operative on a server associated with the publishing system 150.

In operation 1101 a URL from a publication link is received. For example, a link associated with an offer may be activated by a subscriber. Control is passed to operation 110 and process 1100 continues. In operation 1102 a URL indicating a search engine or a website is received. This may occur when a user navigates to a web page via a search engine result or link provided in a website. Control is passed to operation 1110 and process 1100 continues.

In operation 1110 an offer detail is provided. For example, a web page associated with an offer by a promoter may be provided which details terms and usage of an offer. Control is passed to operation 1120 and process 1100 continues. In operation 1120 a purchase indication is received. For example, a user may click a link on a web page which causes a purchase transaction to occur. Likewise, a user might indicate intent to purchase an offer by a message received from a mobile phone application, etc. Control is passed to operation 1121 and process 1100 continues. In operation 1121 a determination is made as to whether a subscriber is logged in. If in operation 1121 it is determined that a subscriber is not logged in control is passed to operation 1122 and process 1100 continues. If in operation 1121 it is determined that a subscriber is logged in control is passed to operation 1130 and process 1100 continues.

In operation 1122 a determination is made as to whether a subscriber is registered. If in operation 1122 it is determined that a subscriber is not registered control is passed to operation 410 (FIG. 4) of the subscriber registration process 400. If in operation 1122 it is determined that a subscriber is registered control is passed to operation 1125 and process 1100 continues. In operation 1125 a subscriber provides login information. Control is passed to operation 1121 and process 1100 continues. The determination in operation 1122 may be based on a user input. For example a user interface for logging in may include a feature for indicating whether a subscriber is registered. In at least one embodiment, if a user is not a registered subscriber, an offer may not be available for purchase. A user login and/or registration may be performed using a mobile device which may include an application allowing the user to become a subscriber.

In operation 1130 a donation is added and a cause is selected. A subscriber associated with a publisher may elect to provide a donation in addition to earnings associated with an offer. A subscriber may designate a group or activity associated with publisher to receive compensation and/or donations associated with a subscriber also referred to as a “cause”. A donation and/or designation of a cause may be optional. Control is passed to operation 1140 and process 1100 continues.

In operation 1140 a purchase is transacted via a merchant service. The merchant service system 170 may effect a transaction with a merchant based on an offer. A subscriber may perform check-out on a web page controlled by the merchant service system. Alternately, a subscriber may accept an offer and make a payment using a mobile device, which may then be used to receive the offer from a merchant. An offer may include a machine readable code such as a Quick Reference (QR) code or barcode which may be used to trace the offer. The machine readable code may be unique to a subscriber. For example, if a subscriber activates a link in a text message directed uniquely to the subscriber, an offer may be customized to a subscriber, and may be a single use token. Control is passed to operation 1150 and process 1100 continues. In operation 1150 a transaction is recorded. A transaction record may include information of a subscriber, promoter, publisher, merchant, time, value, etc. A transaction record may be stored in the database 160 (FIG. 1). Control is passed to operation 1160 and process 1100 terminates.

An offer may generate compensation for participants in the system according to various arrangements. For example, an offer may be purchased by a subscriber for one hundred dollars which may be used at a merchant identified by a promoter to obtain one hundred dollars worth of merchandise. A promoter who has registered the merchant and/or obtained the offer may be compensated based on the offer purchase. For example, a percentage and/or a value associated with offers purchased for the merchant might be allocated to the promoter. Such an allocation might be time limited. A publisher might be compensated based on a value of offers purchased which were published in a publication of a publisher. A provider of the publication system 150 might be compensated based on offers purchased.

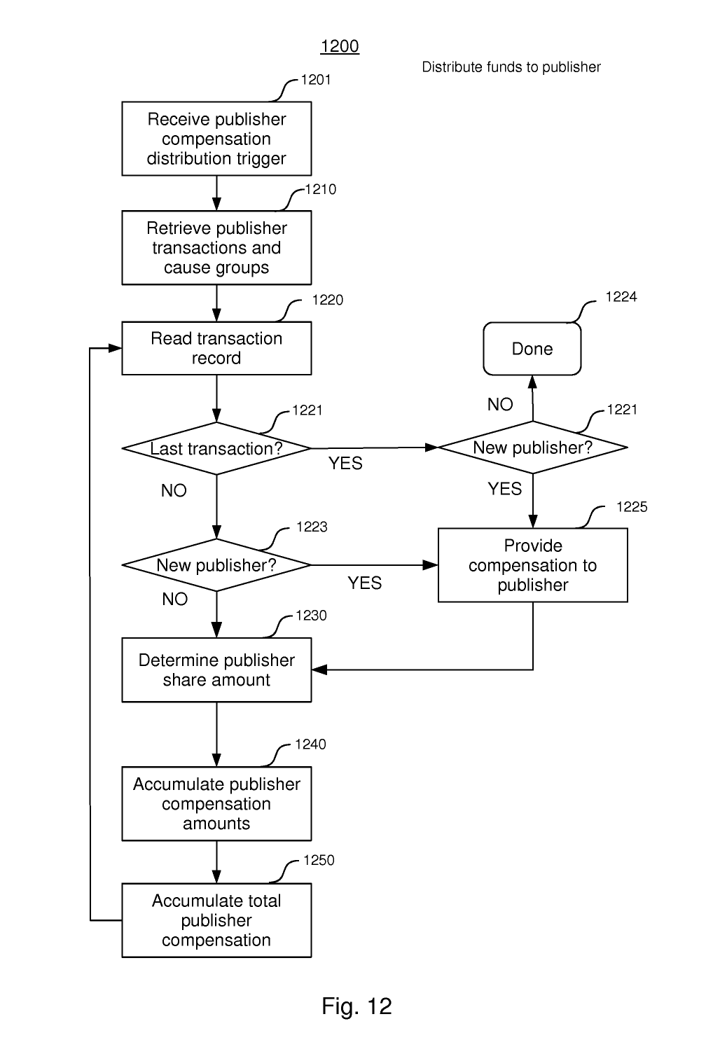

As illustrated in FIG. 12 a process 1200 for distribution of compensation is provided. The process 1200 may be operative on a server associated with the publication system 150. Compensation may include any type of consideration including cash, credit, a discount, services, products, and/or other forms of accommodation.

In operation 1201 a publisher compensation distribution trigger event is received. A trigger event may be a calendar event such as a day of the week or month, may be based on an earnings threshold, may be on-demand from a publisher, etc. Control is passed to operation 1210 and process 1200 continues. In operation 1210 publisher transactions and cause groups are retrieved. Publisher transactions may be any settled transactions associated with a publisher. A cause may distinguish compensation distribution as previously noted. For example, a publication of a national organization acting as a publisher might earn compensation designated to a local chapter acting as a cause. Control is passed to operation 1220 and process 1200 continues. A publisher may be provided with information associated with the publication system 150 (FIG. 1). When compensation is provided to a publisher any information available may be provided. For example, performance information associated with an offer, a promoter, a merchant, a cause, etc. may be provided to a publisher.

In operation 1220 a transaction record is read. A transaction record such as that in operation 1150 of process 1100 (FIG. 11) may be read. Control is passed to operation 1221 and process 1200 continues. In operation 1221 a determination is made as to whether a last transaction record is read. If in operation 1221 it is determined that a last transaction record is read control is passed to operation 1222 and process 1200 continues. In operation 1222 a determination is made as to whether a new publisher is detected. If in operation 1222 a new publisher is detected control is passed to operation 1225 and process 1200 continues. If in operation 1222 a new publisher is not detected, control is passed to operation 1224 can process 1200 terminates. If in operation 1221 it is determined that a last transaction record is not read control is passed to operation 1223 and process 1200 continues.

In operation 1223 a determination is made as to whether a new publisher is detected. If in operation 1223 it is determined that a new publisher is not detected control is passed to operation 1230 and process 1200 continues. If in operation 1223 it is determined that a new publisher is detected control is passed to operation 1225 and process 1200 continues. In operation 1225 compensation is provided to a publisher. For example, an ACH, a PayPal transaction, and/or paper check may be delivered to a publisher. Control is passed to operation 1230 and process 1200 continues.

In operation 1230 a publisher share amount is determined. Any sort of compensation method and/or amount may be determined. Publisher compensation may be based on a percentage of offers purchased. Publisher compensation may include a donation determined by a subscriber. Control is passed to operation 1240 and process 1200 continues. In operation 1240 compensation associated with a publisher is accumulated. A total amount due to a publisher and/or a cause may be tracked. A percentage of transactions and/or a donation amount associated with a transaction and a publisher and/or a cause may be accumulated. Control is passed to operation 1250 and process 1200 continues. In operation 1250 total compensation associated with a publisher is accumulated. Control is passed to operation 1220 and process 1200 continues.

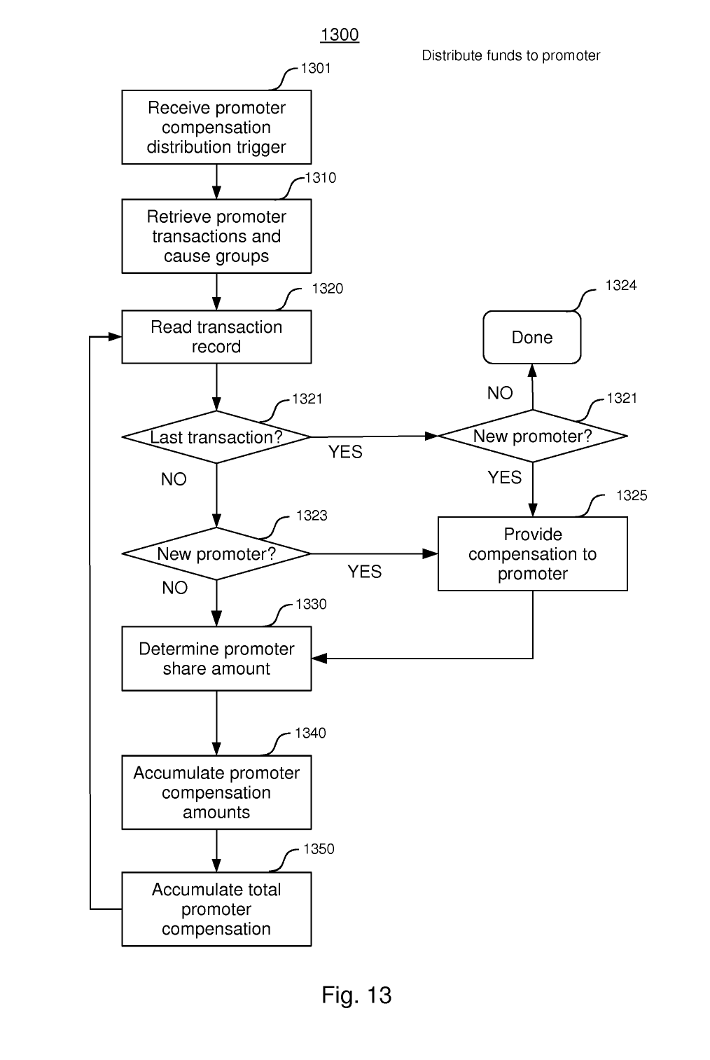

As illustrated in FIG. 13 a process 1300 for distribution of compensation (funds) to a promoter is provided. The process 1300 may be operative on a server associated with the publication system 150.

In operation 1301 a promoter compensation distribution trigger event occurs. A trigger event may be a calendar event such as a day of the week or month, may be based on an earnings threshold, may be on-demand by a promoter, etc. Control is passed to operation 1310 and process 1300 continues. In operation 1310 promoter transactions grouped by cause are retrieved. Promoter transactions may be any settled transactions associated with a promoter. A merchant may distinguish compensation distribution to a promoter as previously noted. For example, a purchase of an offer associated with a merchant recruited by a promoter may generate compensation for the promoter even though the offer is purchased by a subscriber associated with a publisher, i.e., a promoter may receive compensation which is not associated with a publisher associated with the promoter. Control is passed to operation 1320 and process 1300 continues.

In operation 1320 a transaction record is read. A transaction record such as that in operation 1150 of process 1100 (FIG. 11) may be read. Control is passed to operation 1321 and process 1300 continues. In operation 1321 a determination is made as to whether a last transaction record is read. If in operation 1321 it is determined that a last transaction record is read control is passed to operation 1322 and process 1300 terminates. If in operation 1321 it is determined that a last transaction record is not read control is passed to operation 1323 and process 1300 continues. If in operation 1322 it is determined that a new promoter is detected, control is passed to operation 1325 and process 1300 continues. If in operation 1322 it is determined that a new promoter is not detected, control is passed to operation 1324 and process 1300 terminates.

In operation 1323 a determination is made as to whether a new promoter is detected. If in operation 1323 it is determined that a new promoter is not detected control is passed to operation 1330 and process 1300 continues. If in operation 1323 it is determined that a new promoter is detected control is passed to operation 1325 and process 1300 continues. In operation 1325 compensation is provided to a promoter. For example, an ACH, a PayPal transaction, an in-kind exchange, or paper check may be delivered to a promoter. Any sort of compensation may be provided to a promoter. Control is passed to operation 1330 and process 1300 continues.

In operation 1330 a promoter share amount is determined. Any sort of compensation method and/or amount may be determined. Promoter compensation may be based on a percentage of offers purchased. Control is passed to operation 1340 and process 1300 continues. In operation 1340 compensation associated with a promoter is accumulated. A total amount due to a promoter may be tracked. A donation amount and/or an amount based on a merchant, a purchase by a subscriber, a publisher, etc. may be used to determine compensation of a promoter. Control is passed to operation 1350 and process 1300 continues. In operation 1350 total compensation associated with a promoter is accumulated. Control is passed to operation 1320 and process 1300 continues.

While the embodiments have been described in terms of email based publishing, other forms of publishing might be used within the scope and spirit of the embodiments. For example publication via a blog, a social media platform, SMS. MMS, voice, and/or other publishing apparatus may be used. Likewise while a browser based communication has been described for registration, other equivalent communication services might be used alone or in combination to implement the embodiments. A subscriber might register by “Like” to a FaceBook® page, by following a Twitter feed, etc. Subscriber information may be obtained from social media platforms, etc.

A system and method for sponsored publishing is described. Offers are provided to underwrite an electronic publication system. A sponsoring organization or promoter may earn compensation by recruitment of merchants who provide offers for purchase and redemption. A publishing organization may earn compensation based on offers purchased based on publication of content provided by the publisher to subscribers associated with the publisher. A publisher may register subscribers via a ‘walk-up’ such as a website and/or may upload subscriber information. An offer may only be available to registered subscribers.

Purchases of offers are tracked through electronic commerce, and a coupon or other proof of purchase may be provided to a merchant associated with an offer. A subscriber may elect to add a contribution to compensation associated with a purchase. A subscriber may designate a cause associated with a purchase and/or a donation. Organizations at any scale may take advantage of the benefits of the system and method described herein. For example, a national organization such as the American Legion might enlist local chapters to use the system as part of local newsletters and/or promotional campaigns. Likewise a national corporation might advertise through local organizations identified by and with local franchises.

What is claimed is:

1. A method comprising:
receiving a publication trigger event;
retrieving content indicated by the event;
obtaining information of a subscriber of the publication;
selecting, by a processor, an advertisement based on the subscriber; and
compensating a publisher of the publication based on the advertisement.

2. The method of claim 1 further comprising:
receiving the content as the trigger event.

3. The method of claim 1 further comprising:
obtaining the information of the subscriber from the publisher; and
procuring confirmation of the information of the subscriber from the subscriber.

4. The method of claim 1 further comprising:
selecting the advertisement based on geographic information associated with the advertisement and the subscriber.

5. The method of claim 1 further comprising:
selecting the advertisement based on a category associated with the advertisement and approved by the publisher.

6. The method of claim 1 further comprising:
delivering the publication as an email message including a URL; and
compensating a promoter based on the advertisement and the URL.

7. The method of claim 1 further comprising:
providing compensation to the publisher based on a purchase amount associated with the advertisement and a point of sale donation; and
providing compensation to a promoter based on a time interval associated with the purchase amount.

8. The method of claim 1 further comprising:
receiving registration information of the subscriber from publishers;
associating the subscriber with publications of the publishers until the subscriber rejects the subscription

9. The method of claim 8 further comprising:
selecting the advertisement based on a ranking of the publishers for the advertisement.

10. A system comprising:
a publisher system providing content; and
a publication system device receiving a publication trigger event, retrieving content indicated by the event, obtaining information of a subscriber of the publication, selecting an advertisement based on the subscriber, and compensating a publisher of the publication based on the advertisement.

11. The system of claim 10 further comprising:
a promoter system providing information of the advertisement; and
a subscriber system receiving the publication based on an affiliation shared by a promoter and a subscriber.

12. A non-transient computer readable storage medium containing an instruction for causing a computer to perform an operation comprising:
detecting an event;
retrieving content indicated by the event;
obtaining information of a subscriber of a publication associated with the event;
selecting an offer based on the subscriber;
transmitting the publication comprising the content and the offer to the subscriber; and
compensating a publisher of the publication based on redemption of the offer.

13. The computer readable storage medium of claim 12 wherein the operation further comprises:
detecting the event comprising receiving a message from the publisher.

14. The computer readable storage medium of claim 12 wherein the operation further comprises:
selecting the offer based on a time interval provided by a promoter.

15. The computer readable storage medium of claim 12 wherein the operation further comprises:
associating a merchant with the subscriber when the offer is redeemed; and
compensating a promoter associated with the offer and the merchant based on a time period associated with the offer and an activity of the subscriber during the time period.

16. The computer readable storage medium of claim 12 wherein the operation further comprises:
selecting an advertisement as the offer; and
selecting the advertisement based on a category approved for the publication by the publisher.

17. The computer readable storage medium of claim 12 wherein the operation further comprises:
selecting the offer based on a distribution medium of the publication; and
rendering the publication including the content and the offer to the publisher prior to the publisher prior to the transmitting.

18. The computer readable storage medium of claim 12 wherein the operation further comprises:
obtaining a designation of a recipient from the subscriber;
receiving a registration of a merchant from a promoter; and
providing compensation to the recipient and the promoter when a transaction occurs including the merchant and the subscriber.

19. The computer readable storage medium of claim 12 wherein the operation further comprises:
associating a machine readable code with the offer; and
identifying the subscriber and the redemption based on recognition of the code by the merchant.

20. The computer readable storage medium of claim 12 wherein the operation further comprises:
determining a distribution medium associated with the subscriber; and
selecting the content and an advertisement based on the distribution medium.
